(19) United States
(12) Patent Application Publication
(10) Pub. No.: US 2003/0066221 A1
(43) Pub. Date: Apr. 10, 2003

(54) Advertising and display lamp box with optical catalyst waste gas treatment

(76) Inventor: Wen Hu Cheng, Hsin Chu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/960,953

(22) Filed: Sep. 25, 2001

(51) Int. Cl. G09F 13/04

(52) U.S. Cl. 40/564

(57) ABSTRACT

An advertising and display lamp box with optical catalyst waste gas treatment, including a lamp box main unit, an imaging panel, a waste gas treatment ultraviolet (UV) lamp and a compulsory convection device. On the lamp box main unit are air inlets and air outlets. A panel made of transparent or see-through plastic or glass material is installed at the front of the lamp box, presenting transparent or see-through advertising pictures or media materials that need backlight display. The waste gas treatment UV lamp is installed inside the lamp box main unit. . The compulsory convection device is installed on the lamp box main unit, for drawing outside air through the air inlets into the lamp box main unit. Air flows through the waste gas treatment UV lamp out of the air outlets.

### BACKGROUND OF THE INVENTION

(a) Field of the invention

The invention relates to an advertising and display lamp box with optical catalyst waste gas treatment, more particularly to a waste gas treatment lamp box with such functions including advertising, display, sterilization, deodorization, and waste gas treatment.

(b) Description of the Prior Art

The purpose of a lamp box is to provide advertising and display effects. Generally, a conventional lamp box includes a lamp box main unit. At the front of the lamp box main unit is an imaging panel. The lamp box main unit is designed as an enclosed box; inside which are lamp units and power supply circuit that provide a lighting source. On the front of the imaging panel, which is made of see-through material, is printing of words or diagrams with advertising and display effects. The lighting source inside the lamp box main unit projects light onto the imaging panel, providing contrast for the words or diagrams on the imaging panel.

The above-mentioned conventional lamp box has no other functions but providing advertising and display effects. Furthermore, lamp boxes are generally installed inside railway stations, mass transit stations and buildings.

Therefore, when the conventional lamp boxes are actually used indoors or at crowded locations, since the waste gas inside the buildings could not be discharged. So the waste gas could cause bad effects on human health. Even if installed with an exhaust system, its efficiency is still limited. If we can install an optical catalyst waste gas treatment ultraviolet lamp inside the lamp box, it can be an effective improvement. Therefore, the inventor has come up with the present invention with reasonable design and effective improvement on the aforementioned shortcomings.

### SUMMARY OF THE INVENTION

The primary objective of the invention is to provide an advertising and display lamp box with optical catalyst waste gas treatment, providing such functions as sterilization, deodorization and waste gas treatment, in addition to the original advertising and display functions of a conventional lamp box. Particularly, when installed inside a building, it provides better effects on sterilization, deodorization and waste gas treatment, reducing bad effects of waste gas on human health.

To achieve the above objective, the present invention provides an advertising and display lamp box with optical catalyst waste gas treatment, including a lamp box main unit, an imaging panel, a plurality of waste gas treatment ultraviolet lamps and a compulsory convection device. The lamp box main unit has a plurality of air inlets and air outlets. The imaging panel is installed on a plane of the lamp box main unit. The waste gas treatment ultraviolet lamp is installed inside the lamp box main unit. The compulsory convection device is installed on the lamp box main unit, drawing outside air through the air inlets into the lamp box main unit, through the waste gas treatment ultraviolet lamp, and out of the air outlets. These components constitute the lamp box with waste gas treatment.

To enable better understanding of the characteristics and technical approach of the present invention, please refer to the following description and accompanying drawing.However, it should be understood that the accompanying drawing is provided for reference only, and shall not be based to restrict the present invention.

### BRIEF DESCRIPTION OF DRAWINGS

FIG. 1 is a perspective view of the invention.

FIG. 2 is an exploded view of the invention.

FIG. 3 is a plane view of the invention.

FIG. 4 is a perspective view of the invention while operating.

FIG. 5 is a plane view of the invention while operating.

### DETAILED DESCRIPTION OF THE PREFERRED EMBODIMENT

For better understanding of the technology, technical approach, and anticipated performance and objectives of the present invention, please refer to the detailed description and drawings as follows.

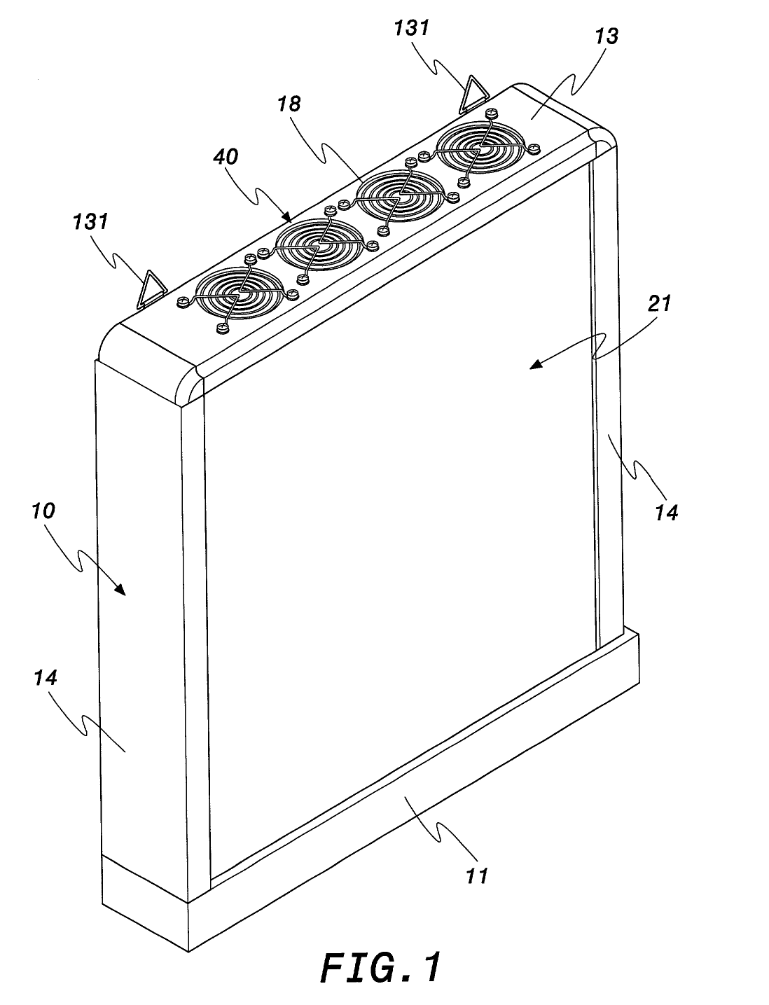

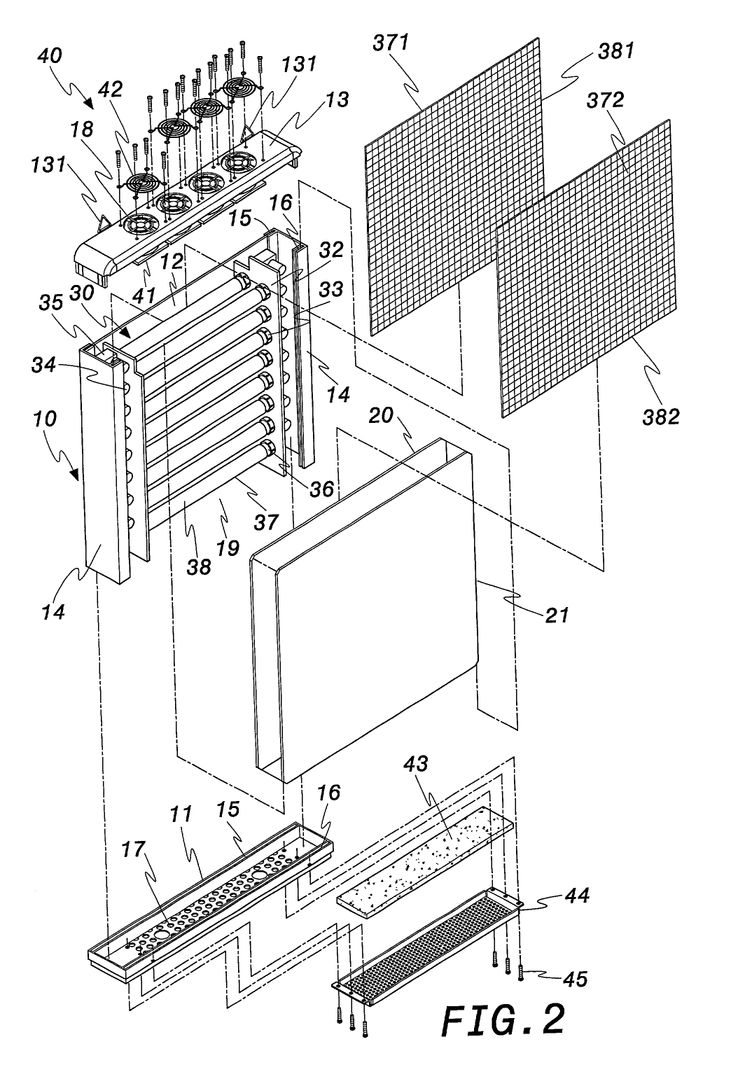

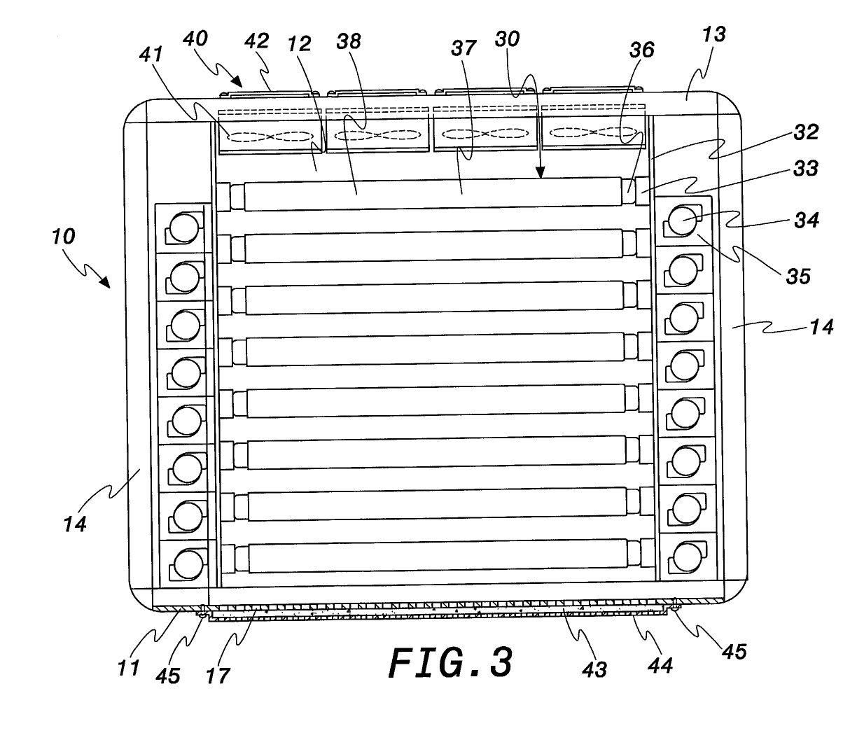

As shown in FIGS. 1 to 3, the invention provides an advertising and display lamp box with optical catalyst waste gas treatment, the lamp box including a lamp box main unit 10, an imaging panel 20, a plurality of waste gas treatment UV lamps 30 and a compulsory convection device 40. The lamp box main unit 10 is an elongated parallelepiped, consisting of a bottom panel 11, a rear panel 12, a top panel 13, and a left and a right side panels 14. The bottom panel 11, the top panel 13 and two side panels 14 are fastened together by joints or screws, forming a parallelepiped frame. Near the rear of the bottom panel 11, the top panel 13 and the side panels 14 each is a rear fixing groove 15, which serves to fasten the rear panel 12 and form a box shape with an opening 19 on the front. Near the front of the bottom panel 11, the top panel 13 and the side panels 14 each is a front fixing groove 16, which serves to fasten an imaging panel 20. On the bottom panel 11 of the lamp box main unit 10 are a plurality of air inlets 17. On the top panel 13 are a plurality of air outlets 18. On top of the top panel 13 of the lamp box main unit 10 are optionally two ringhanger 131 that serve to hang the waste gas treatment lamp box in place.

The imaging panel 20 is made of see-through material. On the imaging panel 20 are printed with wording or diagrams for advertising and display effects. At the front of the imaging panel 20 is a transparent plate (or a see-through plate) 21, which serves to protect the imaging panel 20. The imaging panel 20 and the transparent plate 21 are fitted into the front fixing groove 16 of the bottom panel 11, the top panel 13 and the side panels 14, to assemble the imaging panel 20 in the opening 19 at the front of the lamp box main unit 10, thereby closing the opening 19 at the front (front side) of the lamp box main unit 10, so the lamp box main unit 10 becomes an enclosed box unit.

The waste gas treatment UV lamp assembly 30, consisting of a UV lamp 36, a fiberglass fabric 37 and an optical catalyst plating film 38, is installed inside the lamp box main unit 10. The invention is fastened by screws (not shown in diagram) onto two opposite lamp brackets 32 inside the lamp box main unit 10. On the lamp bracket 32 are a plurality of lamp holders 33. A UV lamp 36 is installed on every two opposite lamp holders 33. Inside the lamp box main unit 10 are installed conventional power supply circuit, such as a starter 34 and a stabilizer 35, supply power required by the UV lamp 36. The exterior of UV lamp 36 is coated by a layer of fiberglass fabric 37 with a specified thickness, which is optionally a fiberglass sleeve or equivalent fiberglass material. The exterior of the fiberglass fabric 37 is coated by a layer of TiO² optical catalyst plating film 38. The aforementioned UV lamp 36, the fiberglass fabric 37 and the optical catalyst plating film 38 constitute a waste gas treatment UV lamp assembly 30. To upgrade the efficiency of the waste gas treatment UV lamp assembly 30, to avoid the visible light produced by the UV lamp from being absorbed by an opaque object, which may cause failure of purifying function to treat waste gas, material for the fiberglass fabric 37 is preferably quartz or glass. The visible light emitted from the UV lamp is used for illumination. Even when the fiberglass fabric 37 is used to coat the UV lamp 36, it will not affect or obstruct the penetration of visible light. When more powerful illumination is required, install fluorescent lamps.

On the rear panel 12 of the lamp box main unit 10 and on the inside of the imaging panel 20 are optionally pasted a fiberglass fabric 371 and 372. The fiberglass fabric 371 and 372 has also a TiO² optical catalyst plating film 381 and 382. When the UV lamp 36 is used, and partial UV light is exposed, it can be absorbed by the optical catalyst plating film, thereby upgrading the efficiency of waste gas treatment.

The compulsory convection device 40, installed on the lamp box main unit 10, consists of a plurality of fans 41. The fans 41 are fastened onto the top panel 13 of the lamp box main unit 10, opposite the air outlets 18. On the outside of the air outlets 18 is optionally a separating screen 42, which serves to prevent extraneous matter from entering the fans 41. On the air inlets 17 of the lamp box main unit 10 is optionally an active carbon filter screen 43. On the outside of the active carbon filter screen 43 is a fixing screen plate 44. The fixing screen plate 44 is tightened by screws 45 onto the bottom panel 11 of the lamp box main unit 10. The fixing screen plate 44 presses and fixes the active carbon filter screen 43 on the air inlets 17, to perform the purposes of filtering dusts and suspended particles. The above components are assembled to configure the present invention of advertising and display lamp box with optical catalyst waste gas treatment.

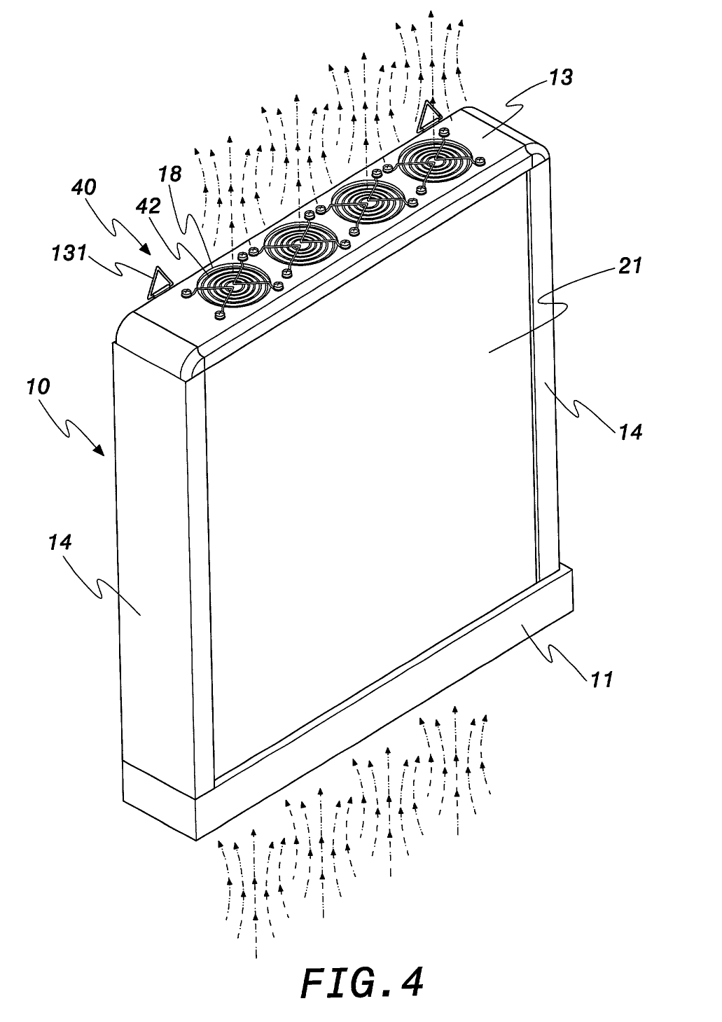

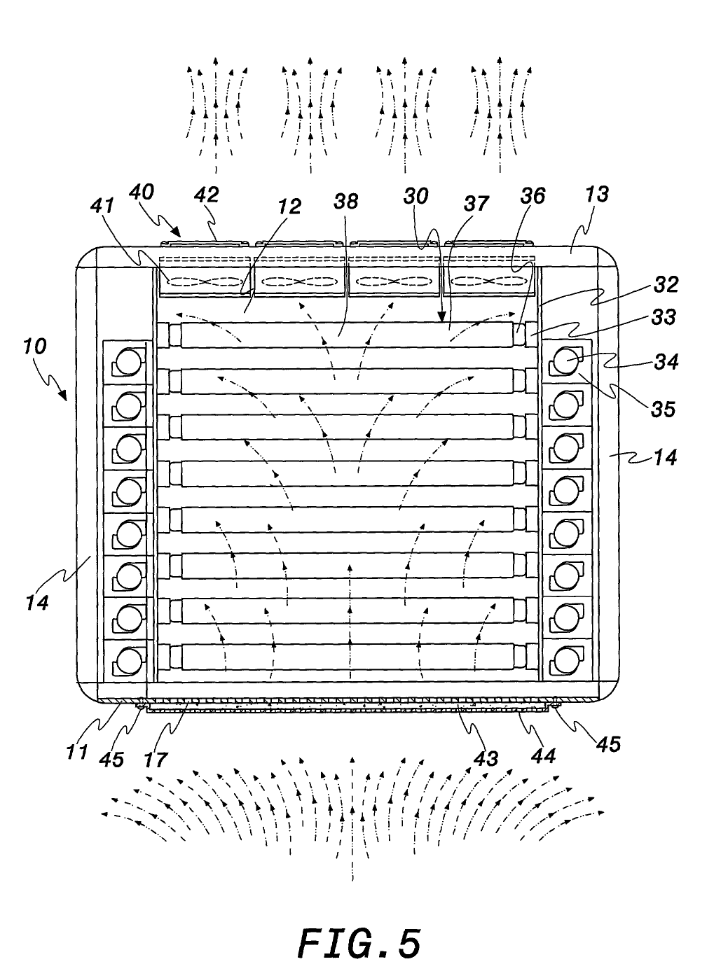

Please refer to FIGS. 4 and 5, the invention uses the compulsory convection device 40 to allow outside air to flow through the waste gas treatment lamp box. When the fans 41 are driven by power supply, outside air is sucked in through the air inlets 17 into the lamp box main unit 10, through the waste gas treatment UV lamp assembly 30, and out of the air outlets 18. Outside air flows through the active carbon filter screen 43 for primary filtering process. When outside air flows through the waste gas treatment UV lamp assembly 30, since the UV lamp 36 is lit, the optical catalyst plating film 38, 381 and 382 continue to oxidize the toxic matter (organic or inorganic) in the air due to optical catalyst reaction, generating water or carbon dioxide. The optical catalyst generates catalyst action under the activation of the UV rays, so the ambient oxygen and water produce free radicals with powerful oxidizing action. Such free radicals with extremely powerful oxidizing action can dissolve all organic matter. The free radicals will kill germs by destroying the cell membranes of germs, and meanwhile acting as a good agent for deodorization and dissolution of organic matter. Therefore, most waste gas can be dissolved to purify air.

In addition to the original advertising and display functions of a lamp box, the invention is also capable of treating waste gas. Particularly, when installed at a railway station, a mass transit station, or inside a building, the invention is capable of achieving excellent effects in sterilization, deodorization and treatment of waste gas, thereby reducing bad effects of waste gas on humans.

To conclude, the invention serving multiple functions of advertising, display and treatment of waste gas, is an unprecedented innovation with industrial applicability, originality and an inventive step. Having satisfied the requirements for a patent right, this application is duly filed in accordance with the patent law. Your favorable consideration shall be appreciated.

Although the present invention has been illustrated and described with reference to the preferred embodiment thereof, it should be understood that it is in no way limited to the details of such embodiment but is capable of numerous modifications within the scope of the appended claims.

What is claimed is:

1. An advertising and display lamp box with optical catalyst waste gas treatment, comprising:
a lamp box main unit having an opening, air inlets and air outlets thereon;
an imaging panel installed on a front side of the lamp box main unit;
a waste gas treatmentUV (ultraviolet) lamp assembly having a plurality of UV lamps installed in a inner side of the lamp box main unit; and
a compulsory convection device installed on the lamp box main unit for drawing outside air through the air inlets into the lamp box main unit, the air flowing through the waste gas treatment UV lamp assembly, and out of the air outlets.

2. The advertising and display lamp box with optical catalyst waste gas treatment as claimed in claim 1, wherein said waste gas treatment UV lamp assembly having a plurality of UV lamps consist of a plurality of fiberglass sleeves or TiO² optical catalyst plating films wrapping the UV lamps, for treatment of waste gas.

3. The advertising and display lamp box with optical catalyst waste gas treatment as claimed in claim 1, wherein the lamp box main unit consists of a bottom panel, a rear panel, a top panel and a left and a right side panels, the bottom panel, the top panel and the side panels constituting a frame body, the bottom panel, the top panel and the side panels each has a rear fixing groove that serves to fix the rear panel, the bottom panel, the top panel and the side panels each has a front fixing groove that serves to fix the imaging panel.

4. The advertising and display lamp box with optical catalyst waste gas treatment as claimed in claim 2, wherein on the rear panel and on the inside of the imaging panel of the lamp box main unit is each a fiberglass fabric, on the fiberglass fabric being an optical catalyst plating film.

5. The advertising and display lamp box with optical catalyst waste gas treatment as claimed in claim 1, wherein to the interior of the lamp box main unit is fastened two opposing lamp brackets, on the lamp bracket being a plurality of lamp holders, each two opposing lamp posts join force to accommodate the installation of the UV lamp.

6. The advertising and display lamp box with optical catalyst waste gas treatment as claimed in claim 1, wherein the lamp box main unit has therein a starter and a stabilizer to supply power required by the waste gas treatment UV lamp assembly.

7. The advertising and display lamp box with optical catalyst waste gas treatment as claimed in claim 1, wherein on the air inlets of the lamp box main unit is an active carbon filter screen, on the outside of the active carbon filter screening being a fixing screen plate, the fixing screen plate being fixed onto the bottom panel of the lamp box main unit, the fixing screen plate serving to fasten the active carbon filter screen onto the air inlets for the purposes of filtering and sucking dusts and suspended particles.

8. The advertising and display lamp box with optical catalyst waste gas treatment as claimed in claim 1, wherein on top of the lamp box main unit are ringhangers to enable hanging the lamp box in place.

9. The advertising and display lamp box with optical catalyst waste gas treatment as claimed in claim 1, wherein the imaging panel being made of see-through or transparent material has wording or diagrams with advertising and display effects.

10. The advertising and display lamp box with optical catalyst waste gas treatment as claimed in claim 1, wherein the imaging panel has a transparent plate at the front thereof, to protect the imaging panel.

11. The advertising and display lamp box with optical catalyst waste gas treatment as claimed in claim 1, wherein the waste gas treatment UV lamp assembly consist of a plurality of UV lamps, a plurality of fiberglass fabrics and a plurality of optical catalyst plating films, the fiberglass fabrics wrapping the exterior of the UV lamps, said optical catalyst plating films wrapping the exterior of the fiberglass fabrics.

12. The advertising and display lamp box with optical catalyst waste gas treatment as claimed in claim 1, wherein the compulsory convection device consists of a plurality of fans, said fans being fastened onto the lamp box main unit, opposite the air outlets.
